(19) United States
(12) Patent Application Publication
(10) Pub. No.: US 2013/0168889 A1
(43) Pub. Date: Jul. 4, 2013

(54) Aggregate Containing Coke and Titanium and Use Thereof to Repair the Lining of Metallurgical Vessels

(71) Applicants: Djamschid Amirzadeh-Asl, Moers (DE); Dieter Fuenders, Duisburg (DE)

(72) Inventors: Djamschid Amirzadeh-Asl, Moers (DE); Dieter Fuenders, Duisburg (DE)

(73) Assignee: SACHTLEBEN CHEMIE GMBH, Duisburg (DE)

(21) Appl. No.: 13/813,666

(22) PCT Filed: Jul. 22, 2011
(86) PCT No.: PCT/DE2011/075173

§ 371 Date: Feb. 27, 2013

(30) Foreign Application Priority Data
Aug. 3, 2010 (DE) 10 2010 038 831.9
Jan. 19, 2011 (EP) 11151418.8

(51) Int. Cl. F27D 1/16

(52) U.S. Cl. CPC F27D 1/1636
USPC 264/30; 423/440

(57) ABSTRACT

An aggregate includes coke and titanium for introduction into metallurgical vessels for increasing the durability and for repairing the refractory lining. The aggregate has a content of titanium-containing compounds and a content of 10 to 98 wt.-% of coke-containing material, based on the total amount of aggregate, which contains no or only small amounts of less than 25 wt.-%, based on the coke containing material of substances being volatile at the temperatures present at a reaction site, whereby the aggregate is obtained by the combined coking of carbonaceous material and titanium-containing compounds.

The invention concerns an aggregate containing coke and titanium, a method for the production thereof and the use thereof for the repair of the lining of metallurgic vessels as well as a method for accelerating the formation of highly refractory titanium compounds by direct reduction in metallurgic processes making use thereof.

The use of titanium-containing aggregates to repair the lining of metallurgic vessels such as for example blast furnaces is known for a long time.

In the most fields, it is the object to convert aggregates containing titanium into forms of highly refractory/wear-resistant compounds containing titanium, such as, for example, TiC, TiN, TiCN etc., which, in subsequent steps, will then deposit themselves in the areas of the respective refractive lining which are endangered by wear processes and are to provide the same protection and/or make repairs.

Using materials containing titanium in mixtures with carbonaceous materials in metallurgic vessels is state of the art technology.

It is also state of the art to blow in coal (pulverized coal injection—named PCI in the following) oil/gas and/or tar, pitch, trough the blow moulding of the blast furnace as an energy source and reducing agent for the smelting process. Coke is moreover used as a fuel and as a reducing agent in the production of iron, for example in blast furnaces. The production of coke takes place through the pyrolysis of bituminous coal. For the smelting, the coke is used with a grain-size of between 20 and 150 mm.

Coal containing raw materials are usually used for the production of PCI-coal, which are ground to a fine grain in a special milling process, as well as being dried in a drying process at low temperatures which usually runs parallel to the milling.

Thus, fine grained titanium substrates are in some cases admixed to the coal-containing raw materials and subsequently blown into the blast furnace, in order to then form titanium carbides or titanium carbonitrides inside the reaction chamber of the blast furnace. In the field of blast furnace technology, it is important to produce the wear-resistant titanium carbide as fast as possible in the area of the gas chamber around the blow mouldings and in the various fluid phases such as pig iron and slag, and then, in a second step, to deposit said wear resistant titanium carbides on the refractory lining to be repaired/protected with a yield as high as possible.

One disadvantage of the coal-containing materials used up until now is that these coal-containing materials usually contain complicated mixtures of various types of hydrocarbons and many other impurities due to ash producers. On one hand, this reduces the desired formation of wear-resistant titanium compounds, and on the other hand it causes undesired obstructions of the desired reaction kinetic, which impairs or significantly reduces the formation of wear-resistant titanium compounds. This reduces the amount of wear-resistant titanium compounds (e.g. TiCN) and the result is that the main part of the applied titanium is removed from the system through slagging without having been used.

The object of the invention is to increase the yield of obtained highly refractory titanium compounds in relation to the utilized titanium-containing materials for use in metallurgical vessels.

In this context the inventors of the present invention found out that the reaction kinetics before the blow mouldings or in the area of the respective fluid phases such as pig iron and slag can be accelerated due to a significant effect.

According to the inventor's experiments, when blowing in PCI-mixtures together with titanium compounds at high speed the respective particles statistically only rarely collide with each other. When the particles do sometimes collide, the titanium compounds are again pushed back by the gassed or released hydrocarbons of the injection coal so that, despite a particle contact, no titanium carbides are formed at this point. Only upon a further collision in the second, third etc. attempt, when the volatile hydrocarbons can no longer exert their repellent influence, the majority of them having been gasified, it is the reaction of “almost pure” carbon and the respective titanium compounds to form titanium carbides possible.

The problem can be solved by provision of the method according to the invention and of the aggregate of coke-containing materials and titanium-containing compounds according to the invention.

Using the method according to the invention, it is thus possible to particularly increase the amount of refractory titanium compounds formed per time unit as well as simultaneously to improve the metallurgic application of the titanium compounds added to the system.

The invention thus also concerns an aggregate of coke-containing material or mixtures of various different coke-containing materials and titanium-containing compounds according to the invention for introduction into a metallurgical vessel.

It was surprisingly found that through the blowing-in of such an aggregate of coke-containing material and titanium-containing materials/compounds, the conversion of the reaction partners for the forming of highly refractory titanium carbonitrides in an immediate reaction (direct reduction) is significantly improved and the yield of titanium carbonitrides is thereby strongly increased.

According to the invention, coke containing material also comprises carbonaceous material such as coal, coke or mixtures of various different coke-containing materials, which contain only a small portion of less than 25 wt.-% preferably less than 10 wt.-% of at the increased temperatures volatile, particularly organic, substances such as hydrocarbons, gases etc. In order to achieve this, the carbonaceous material can be subjected to a prior thermal treatment, where the volatile substances are expelled and can thus no longer interfere with the intimate contact between the coke-containing material and titanium-containing compounds in the metallurgic vessel during use. In the first phase of such a thermal pre-treatment, the material is usually dried in cases where there is a water content present. The aggregate according to the invention may contain up to 60 wt.-%, preferably up to 35 wt.-% water. Usually and according to the use, a partial or complete drying is then required as a thermal pre-treatment in the case of such water contents.

The aggregate of coke-containing material and titanium-containing compounds according to the invention can thus contain particles of the coke-containing material and of the titanium compounds simultaneously as a powder mixture, the grain-size of which is aimed at the intended application. Thus, a grain-size of less than 200 μm, preferably less than 100 μm is used blowing-in a powder mixture, whereas larger grain-sizes of up to 200 mm may be used for the introduction into the metallurgic vessel in other ways.

When, for instance, coke is to be used as carbonaceous material in a mixture, the grain-size can be selected from the blast furnace coke types HK 1 (>80 mm), HK 2 (>60 mm), HK 3 (>40 mm) as well as HK 4 (>20 or 25 mm) where the smaller sizes are preferable. Thus a larger coke can also be further broken down or ground until a grain of less than 10 mm is obtained. The use of coke breeze with a grain-size of up to 10 mm can also be advantageous.

According to the invention, a carbonaceous material which contains no or only small amounts of less than 25 wt.-%, preferably less than 10 wt.-%, based on the carbonaceous material, of particularly organic substances such as hydrocarbons, being volatile at the temperatures present at the reaction location in the metallurgic vessel, can be used instead of or in combination with the coke. Here, petroleum coke, coke breeze, activated carbon or used activated carbon as well as lean coal and anthracite, preferably with a volatile portion of less than 10 wt.-% are mentioned exemplarily.

It is of particular advantage that the coal or the carbonaceous material, which is used for the coking, is added during coking to the titanium-containing compounds in the desired amount so that the forming of the coke takes place in the presence of the titanium-containing materials and a lumpy material is formed which contains coke and titanium-containing materials simultaneously. Said lumpy material can then be adjusted to the desired grain-size by sieving, milling etc. It is also possible to introduce said lumpy material, which simultaneously contains coke and titanium-containing materials into the metallurgic vessel, such as in the case of a blast furnace from above via the filling, as an additive to the charge. However, the lumpy material is also suitable to be ground to a grain-size which is appropriate for blowing-in.

Thus, the particles of the aggregate of coke-containing material and titanium compounds (coke- and titanium-containing aggregate) according to the invention can have a grain-size of 0 to 200, preferably up to 150 mm. The aggregate of coke-containing material and titanium-containing compounds according to the invention shows an advantageous fineness of 90%, preferably 100%, smaller than 100 mm, preferably smaller than 10 mm, more preferred smaller than 1 mm and especially preferred smaller than 0.5 mm. In another advantageous embodiment the aggregate according to the invention is characterized by such a fine coke- and titanium-containing aggregate where 90% of the particles have a diameter not exceeding 100 micrometers. Said last embodiment is particularly suited for blowing into a metallurgic vessel, such as a blast furnace, via blow mouldings.

Subject matter of the invention is also a coke- and titanium-containing aggregate, of which at least 95% of the particles have a diameter of no more than 150 μm and which has a water content of 0.1 to 60%, as well as a method for the production of the aggregate according to the above described procedures, and a method for the production of the aggregate through mixing of the carbonaceous fine grained coke with the fine grained titanium compounds.

Part of the invention is also a coke- and titanium-containing aggregate with a grain-size of 10 to 150 mm and a water content of 0.1 to 15 wt.-%.

Said coke- and titanium-containing aggregate can also be advantageously produced by mixing the coke-containing material with the titanium-containing compounds and, according to the field of application, to mill them together in order to achieve the desired grain-size and inner mixing of the preferred fine particle components.

As described above, the material used as coke producer for the manufacture of the coke such as bituminous coal, e.g. hard coal, brown coal, pitch, tar, and similar carbonaceous materials can be pyrolyzed together with the titanium-containing compounds/materials through exposure to heat under the exclusion of oxygen in a coking stage and, if desired, the resulting, often lumpy pyrolysate of coke- and titanium-containing material can be broken or ground to the desired grain-size according to field of use.

In this manner, a thermal pre-treatment, like a coking, reliably guarantees that the volatile components, which interfere with an intimate contact between the coke- and titanium-containing materials in the blast furnace, are expelled during the coking, thus guaranteeing the intimate contact between the coke- and titanium-containing material. By this procedure, the utilized titanium-containing compounds can already partially or completely react with the coal containing material to form TiOC, TiC, TiCN and similar high refractory compounds. Thus, the mixture, or the partially physically interconnected materials (coke-containing material and titanium-containing material), which is also to be understood as the coke- and titanium-containing aggregate according to the invention, can immediately react at the reaction site in the metallurgic vessel and without interfering “evaporation reactions” of the volatile components, to form titanium carbonitrides.

The aggregate of coke-containing material and titanium-containing compounds according to the invention may contain 10 to 98 wt.-%, preferably 25 to 95 wt-%, particularly preferred 35 to 90 wt.-% very particularly preferred 45 to 80 wt.-% coke-containing material, coke in particular, calculated from the total carbon content and based on the, preferably at 105° C., dried material.

The aggregate of titanium-containing compounds and carbonaceous material according to the invention, especially when produced through common coking, preferably contains 10 to 65 wt.-% of titanium-containing material/compounds and an amount of 35 to 90 wt.-% of coke-containing material, preferably an amount of 20 to 55 wt.-% of titanium-containing material/compounds and an amount of 45 to 80 wt.-% of coke-containing material. All indications of the description in wt.-% of solid contents refer to a material dried at 105° C.

The titanium-containing materials used for the production of the aggregate according to the invention usually contain 5 to 60, preferably 10 to 60 wt.-% Ti, mostly as TiO₂ or in combination with other metals as titanates. As synthetic titanium dioxide-containing materials, those from the production of titanium dioxide according to the sulphate- or chloride-processes, intermediate- or by-products or residual materials from the running TiO₂-production can be used. It is also possible to use residues or wastes from the chemical- and paper industry or from titanium extraction as synthetic titanium-containing materials. The typical TiO₂ residues are TiO₂ residues from the TiO₂ production according to the sulphate method. Catalysts containing titanium e.g. DENOX-catalysts or Claus-catalysts used in the framework of the invention can also be used advantageously. Furthermore, materials such as natural titanium carriers for example ilmenite, ilmenite sand, rutile sand and/or slags containing titanium (e.g. sorel slag), which are able to form refractory titanium carbonitrides at the reaction site in the blast furnace, can be used. The abovementioned synthetic and natural titanium-containing carriers can be used individually or in admixtures for the production of coke-containing titanium compounds.

Besides carbon and TiO₂ (calculated from the total titanium) the aggregate of coke-containing material and titanium-containing compounds according to the invention can contain other components of metal oxides and/or metal hydroxides such as e.g. Al₂O₃, iron oxide, CaO, MgO, SiO₂, ZrO₂, Al(OH)₃Ca(OH) ₂, Mg(OH)₂ or mixed oxides thereof as well as mixtures of several components thereof as well as further components such as slag producers in an amount of preferably up to 50 wt.-% of the total weight.

According to the use, the aggregate of coke-containing material and titanium-containing compounds according to the invention can also be blown in into the area of the pedestal close to the damaged areas. In this case, the aggregate according to the invention can preferably have a water content of 0.1 to 15 wt.-%.

Alternatively, the addition of the aggregate of coke-containing material and titanium-containing compounds according to the invention can take place during the preparation of the fine-grained injection coals (PCI) for the blowing into the blast furnace. Here, the carbonaceous raw materials can already be added to the aggregate of coke-containing material and titanium-containing compounds according to the invention. The added amount of the aggregate of coke-containing material and titanium-containing compounds according to the invention can be 0.5 to 100 wt.-%, preferably 0.5 to 80 wt. %, more preferred 1 to 50 wt.-% and much preferred 2 to 40 wt.-% of the blown-in material.

Alternatively, the aggregate of coke-containing material and titanium-containing compounds according to the invention can be added to a carbonaceous material such as oil, heavy oil, tar, pitch, and/or natural gas and subsequently blown into the metallurgic vessel via the blow mouldings.

In a similar way, a joint blowing-in of the aggregate of coke-containing material and titanium-containing compounds according to the invention with blowing-in materials such as plastics can take place via the blow mouldings into the metallurgic vessel in an amount of up to 50 wt.-% based on the total amount of blown-in material.

The coke- and titanium-containing aggregate is distinguished by the fact that the time-consuming and costly coking processes which only take place in the blast furnace can be saved and that the used materials can be used free of volatile components and other impurities. The use of the aggregate is thus “energy neutral”, since no energy is extracted from the blast furnace for evaporation of volatile components or for coking of the coals, and since none of the coke added to the blast furnace for iron production is used therefore.

When the fine-grained coke particles (without volatile component materials) are combined with the highly reactive titanium particles, the formation of titanium carbides takes place at a significantly faster rate than with the blowing-in of usually used pulverized coal particles. By introducing the coke- and titanium-containing aggregates into an oven, the formation of highly wear-resistant titanium compounds takes place in situ due to the local proximity of the two reactants without the reaction being significantly hindered by volatile components. Due to this, significantly more high refractory titanium compounds are formed per unit of time, which then deposit themselves on the refractory lining to be protected.

By introducing coke-containing titanium carriers for the formation and deposit of wear-resistant titanium compounds, a direct reduction is thus triggered. Due to this effect of the direct reduction, lower amounts of titanium-containing substances are required than with use of the titanium-containing carriers of the current state of the art technology. Thus, the use of expensive titanium carriers is reduced and the economic efficiency of the process is increased.

The reduced usage amounts and the higher conversion rate to Ti(C,N)-compounds then leads to improved slag quality through reduced TiO₂-content and thus to easier exploitation of the slag sand.

1. Aggregate, comprising:
coke and titanium for introduction into metallurgical vessels for increasing the durability and for repairing the refractory lining, with a content of titanium-containing compounds and with a content of 10 to 98 wt.-% of coke-containing material, based on the total amount of aggregate, which contains no or only small amounts of less than 25 wt.-%, based on the coke containing material of substances being volatile at the temperatures present at a reaction site, whereby the aggregate is obtained by the combined coking of carbonaceous material and titanium-containing compounds.

2. Aggregate according to claim 1, obtainable by the combined coking of carbonaceous material and titanium containing compounds and at least one of metal oxides or metal hydroxides selected from the group consisting of Al₂O₃, iron oxides, CaO, MgO, SiO₂, ZrO₂, mixed oxides and mixtures thereof in an amount of up to 50 wt.-%, based on the total amount of aggregate.

3. Aggregate according to claim 1, wherein a coke producer comprising, pyrolyzable carbonaceous compounds is used as carbonaceous material.

4. Aggregate according to claim 1, with a content of coke-containing material with less than 10 wt.-%, based on the coke-containing material, of substances being volatile at the temperatures present at the reaction site.

5. Aggregate according to claim 1 with 25 to 95 wt.-% of coke containing material, based on the total amount of aggregate.

6. Aggregate according to claim 1, with a content of 10 to 65 wt.-% titanium containing compounds and a content of 35 to 90 wt.-% coke containing material, based on the total amount of aggregate.

7. Aggregate according to claim 1, with a particle size of 90%, smaller than 100 mm.

8. Aggregate according to claim 1, with a particle size of 90% less than 200 μm.

9. Process for producing a coke- and titanium-containing aggregate according to claim 1, comprising:
mixing titanium-containing compounds with a carbonaceous material as coke producer; and
subjecting the resulting mixture to a thermal treatment in a coke oven or fluidized bed furnace.

10. Process according to claim 9, wherein the titanium-containing compounds are mixed with coal and the resulting mixture is subjected to a coking under exclusion of oxygen in a coke oven or fluidized bed furnace.

11. Process according to claim 9, wherein, after the coking, the mixture is subjected to a comminution step comprising milling or sieving.

12. Process for the production of a coke- and titanium-containing aggregate according to claim 1, comprising:
mixing the titanium-containing compounds with coke and/or petroleum coke,
drying the resulting mixture, and
if required, grinding the dried mixture in a mill.

13. A process for the acceleration of the formation of highly refractory titanium carbides through direct reduction in metallurgical processes, comprising introducing a fine-grained coke- and titanium-containing aggregate according to claim 1, through blowing-in, into a metallurgical vessel.

14. Process according to claim 13, wherein PCI-coals are added to the coke- and titanium-containing aggregate for the blowing-into the blast furnace and said mixture is then blown in through blow mouldings, wherein the addition to the coke- and titanium-containing aggregate of the PCI-coals lies at 0.5 to 80 wt.-% of the total amount of the blown-in mixture.

15. (canceled)

16. Aggregate according to claim 1, with 35 to 85 wt.-% of coke containing material based on the total amount of aggregate.

17. Aggregate according to claim 1, with a particle size of 90% smaller than 10 mm.

18. Aggregate according to claim 1, with a particle size of 90% smaller than 1 mm.

19. Aggregate according to claim 1, with a particle size of 90% less 100 μm.

20. Process according to claim 9, wherein the thermal treatment comprises pyrolysis.

21. Process according to claim 14, wherein the addition to the coke- and titanium-containing aggregate of the PCI-coals lies at 2 to 40 wt.-% of the total amount of the blown-in mixture.
